(19) United States
(12) Patent Application Publication
(10) Pub. No.: US 2026/0354423 A1
(43) Pub. Date: Nov. 12, 2026

(54) MILK PROTEIN BEVERAGE WITH VISCOSITY STABILITY

(71) Applicant: Trilliant Food and Nutrition LLC, Little Chute, WI (US)

(72) Inventors: Madison L. FOMICH, Oshkosh, WI (US); Gayl M. KERBS, Greenville, WI (US); Diego BENITEZ, Appleton, WI (US); Ferhan OZADALI, Neenah, WI (US); Brian THON, Appleton, WI (US)

(73) Assignee: Trilliant Food and Nutrition LLC, Little Chute, WI (US)

(21) Appl. No.: 19/728,208

(22) Filed: Jul. 1, 2026

Related U.S. Application Data
(63) Continuation of application No. 19/246,335, filed on Jun. 23, 2025.
(60) Provisional application No. 63/685,200, filed on Aug. 20, 2024.

(51) Int. Cl. A23L 2/66; A23C 9/142; A23C 9/152; A23F 5/24; A23G 1/32; A23G 1/46; A23L 2/56

(52) U.S. Cl. CPC A23L 2/66; A23C 9/1422; A23C 9/1522; A23F 5/243; A23G 1/325; A23G 1/46; A23L 2/56

(57) ABSTRACT

A milk protein beverage, including: milk protein; one or more polyphenol-containing agent; and one or more calcium-binding chelator compound, wherein the milk protein beverage has a viscosity difference of less than 150 cP across a temperature range of 2 to 30 °C. A method of producing the milk protein beverage, the method including: forming a first liquid including water, one or more polyphenol-containing agent, and one or more calcium-binding chelator compound; forming a second liquid including a milk concentrate; combining the first liquid and the second liquid to form a third liquid; homogenizing the third liquid; and thermally processing the third liquid to form the milk protein beverage, the thermal processing including a temperature of 105 to 140 °C. A milk protein beverage, including: milk protein; and one or more calcium-binding chelator compound, the milk protein beverage having a viscosity difference of less than 150 cP across the temperature range.

### CROSS-REFERENCE TO RELATED APPLICATION

This application is a continuation of U.S. patent application Ser. No. 19/246,335 filed Jun. 23, 2025, which claims the benefit of U.S. Provisional Patent Application No. 63/685,200, filed Aug. 20, 2024, which are incorporated by reference herein in their entireties.

### TECHNICAL FIELD

Embodiments of the present disclosure generally relate to milk protein beverages having stable viscosities as a function of temperature. Embodiments of the present disclosure relate to milk protein beverages including calcium-binding chelator compounds, and methods of making the same.

### BACKGROUND

In recent years, shelf-stable high-protein ultrafiltered milk beverages have emerged as a compelling option for health-conscious consumers seeking nutritious alternatives to traditional dairy products. These beverages, enriched through an advanced ultrafiltration process to concentrate protein content, while reducing lactose (Salunke et al., 2021), offer a potent combination of taste, convenience, and nutritional benefits. As evidence grows showing that protein-rich diets can improve muscle recovery (Wu, 2016, Pasiakos et al., 2013), weight management (Mahkos, 2020, Morengna and Mann, 2012), bone health (Bonjour, 2005, Ginty, 2007), and overall wellness (Wu, 2016, Morengna and Mann, 2012). These beverages are garnering increasing attention for their ability to deliver essential nutrients in a convenient, delicious, and widely distributed form.

The physical properties of nutritional beverages, such as colloidal stability and viscosity, can directly impact taste, quality perception, and mouthfeel (Wagoner et al., 2022). Such attributes are often intertwined with the temperatures at which they are consumed, including changes in viscosity (Kelleher et al., 2018). This is especially true for protein-rich beverages, as protein is susceptible to numerous temperature-dependent aggregation interactions such as clumping, micelle formation, complexation, coaggregation, gelation, and other self-assembly behaviors, which can be reversible or irreversible (Kelleher et al., 2018, Kelleher et al., 2020, Barone et al., 2022, Singh et al., 2022, Singh et al., 2019, Vogel et al., 2021). These various interactions can significantly affect the texture, taste perception, and overall drinking experience of the consumer, making temperature a crucial factor in consumer satisfaction and product acceptance (Vogel et al., 2021, Singh et al., 2022). Whether chilled to refreshingly cold temperatures of about 2 °C to 4 °C (a typical refrigerator temperature range) or served warm, for a more comforting experience, the temperature at which a high-protein nutritional beverage is consumed can either enhance or lessen its palatability and drinkability, affecting the consumers overall experience.

Achieving optimal viscosity and mouthfeel are important for improving overall enjoyment, nutritional perception, and consumer acceptance of high-protein nutritional beverages (Vogel et al., 2021, Liu et al., 2021). The texture plays an important role in a consumer's sensory experience by influencing palatability and feelings of satiety (Mattes and Rothacker, 2001, Bertenshaw et al., 2013, Stribitcaia et al., 2022). Consumers also have expectations that the product texture should not change significantly between refrigeration and room temperature. Ideally, a balanced and stable viscosity provides a smooth and creamy texture that coats the palate without being overly thick or runny, allowing the drink to flow smoothly and pleasantly in the mouth regardless of, or unaffected by the beverage temperature. This beverage consistency not only enhances the drinking experience but also contributes to perceived quality and nutritional value. Whether consumed as a quick on-the-go snack or as part of a post-workout regimen, the consistent mouthfeel can make high-protein drinks more enjoyable and easier to incorporate into daily dietary routines, encouraging regular consumption for health and wellness benefits. Achieving this optimal texture requires careful formulation and processing techniques to strike the right balance between protein concentration, viscosity, and overall sensory appeal, and to maintain these properties for an appropriate length of time from formation of the drink to its ultimate enjoyment. One major hurdle in high protein-based beverage production is the temperature driven onset of gelation or significant increase in viscosity caused by various protein interactions, creating an unfavored product with too high of a viscosity. Not only would prevention of the phenomenon improve the palatability of high protein beverages, but further regulation of the viscosity throughout the whole process increases the overall perceived stability and quality of the product.

Several previous studies have investigated various properties, including viscosity, of high-protein beverages, including milk-based nutritional beverages. For example, De Kort et al., 2019, reported that undesirable turbidity of micellar casein isolate (MCI) can be decreased by adding certain calcium-chelating agents, in some cases without significantly increasing the viscosity of the MCI. At room temperature, it was found that the viscosity of MCI increased with the addition of sodium phytate (SP), trisodium citrate (TSC), and disodium phosphate.

Goulder and Harte, 2022 investigated low-temperature gelation in milk protein concentrates (MPCs) using calcium-binding salts, finding that low-temperature gelation occurred in MPC at protein concentrations of 16.0% and higher. Goulder and Harte reported that MPC samples including a variety of salts behaved as non-Newtonian liquids, displaying shear-thinning behavior, and were able to prevent cold set gelation at concentrations under 1.0 mM. At concentrations above 1.0 mM, the calcium-binding salts formed thermally irreversible gels. Cold set gelation occurs as thermally reversible gels, which demonstrates a differing mechanism for gel formation. The initial cold set gelation being a thermally reversible gel demonstrates that ionic interactions (calcium bridging) and hydrogen bonding are a driving force in gel formation (Lu et al., 2016). The formation of a thermally irreversible gel demonstrates a shift in the driving factor for gel formation to covalent interactions (disulfide bond formation) or hydrophobic interactions. Goulder and Harte, 2022 believed that the gel formation at the high salt concentrations is due to disassociating of the casein micelle, and reaggregation of monomer caseins by hydrophobic interaction. Goulder and Harte, 2022 heated the MPC dispersions to only 50 °C before chilling the product, to preserve the integrity of whey proteins which changes their functionality within the matrix. Many heating methods from common industrial practices rely on thermal processing for sterilization purposes, such as retorting, and these processes would denature and gel the whey proteins, while dissociating the casein micelle, thus altering the structure of the formed gel. Denaturation of whey proteins disrupts the native protein state exposing hydrophobic regions of the protein, encouraging more hydrophobic interactions and disulfide bond formation within the casein-whey matrix, thus creating a differing structure.

Alexander, 2022 investigated cold gelation in casein-containing nutritional liquids. It was found that the addition of purified small polyphenolic catechin compounds decreased the cold gelation effect in beverages having a high casein content. Catechin additives in dairy products are not well-studied, may not be Generally Recognized as Safe (GRAS) by the US Food and Drug Administration, and the resulting beverages may not align with a “clean label” product.

Therefore, there remains an ongoing need for improved beverage compositions, including milk protein beverages that avoid cold-gelation and can maintain a stable viscosity across a typical drinking temperature range.

### SUMMARY

Some embodiments of the present disclosure provide a milk protein beverage. The milk protein beverage may include: milk protein having a concentration of 4 to 20% w/w; one or more polyphenol-containing agent; and one or more calcium-binding chelator compound having a concentration of 1 to 30 mM, where the milk protein beverage has a viscosity difference of less than 150 cP across a temperature range of 2 to 30 °C.

Some embodiments of the present disclosure provide a method of producing a milk protein beverage. The method may include: forming a first liquid including water, one or more polyphenol-containing agent, and one or more calcium-binding chelator compound having a concentration of 0.5 to 2% w/w; forming a second liquid including a milk concentrate having a milk protein concentration of 4 to 20% w/w; combining the first liquid and the second liquid to form a third liquid; homogenizing the third liquid at a pressure of 2500 to 5000 psi; and thermally processing the third liquid to form the milk protein beverage, the thermal processing having a temperature of 105 to 140 °C and a duration of 4 to 10 minutes, where all concentrations are provided relative to a total concentration of the milk protein beverage.

Some embodiments of the present disclosure provide a milk protein beverage. The milk protein beverage may include: milk protein having a concentration of 4 to 20% w/w; and one or more calcium-binding chelator compound having a concentration of 1 to 30 mM, where the milk protein beverage has a viscosity difference of less than 150 cP across a temperature range of 2 to 30 °C.

### BRIEF DESCRIPTION OF THE DRAWINGS

So that the way the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 schematically illustrates casein micelle interactions according to some embodiments of the present disclosure; and

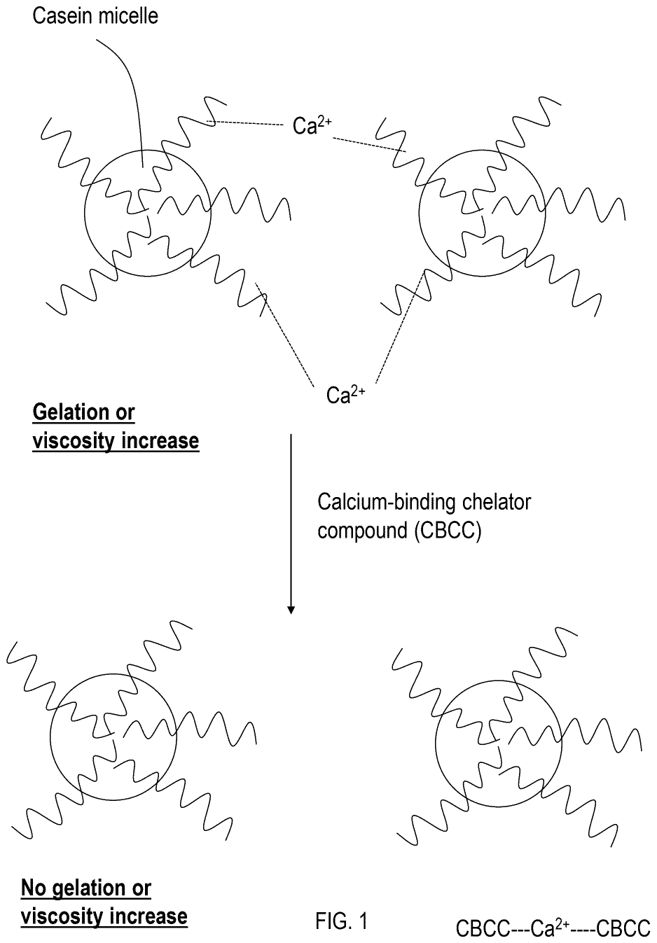

FIG. 2 illustrates a process flow method according to some embodiments.

FIG. 3 shows viscosity as a function of temperature of milk protein beverages according to some embodiments.

FIG. 4 shows viscosity as a function of the percentage of additive of milk protein beverages according to some embodiments.

FIG. 5 shows particle size distributions of milk protein beverages according to some embodiments.

FIG. 6 shows measured viscosities of milk protein beverages according to some embodiments.

FIG. 7 shows images of viscosity instability in milk protein beverages according to some embodiments.

FIG. 8 shows particle size distributions of milk protein beverages according to some embodiments.

FIG. 9 shows viscosity as a function of calcium-binding chelator compound concentration according to some embodiments.

FIG. 10 shows viscosity as a function of calcium-binding chelator compound concentration and storage time according to some embodiments.

FIG. 11 shows particle size distributions of milk protein beverages according to some embodiments.

To facilitate understanding, identical reference numerals have been used, where possible, to designate identical elements that are common to the figures. It is contemplated that elements and features of one embodiment may be beneficially incorporated in other embodiments without further recitation.

The patent or application file contains at least one drawing executed in color. Copies of this patent or patent application publication with color drawing(s) will be provided by the Office upon request and payment of the necessary fee.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

The term “about” as used herein means approximately or nearly and, in the context of a numerical value or range set forth, means a variation of ±15% or less of the numerical value. For example, a value differing by ±14%, ±10%, ±5%, ±2%, ±1%, ±0.5%, or ±0.1% would satisfy the definition of “about.”

Reference throughout the disclosure to “one embodiment,” “some embodiments,” “one or more embodiments” “an embodiment,” and the like means that a particular feature, structure, material, or characteristic described in connection with the embodiment is included in at least one embodiment of the disclosure. Thus, the appearances of the phrases such as “in one or more embodiments,” “in some embodiments,” “in one embodiment,” “in an embodiment” and the like in various places throughout this specification are not necessarily referring to the same embodiment of the disclosure. Furthermore, the particular features, structures, materials, or characteristics may be combined in any suitable manner in one or more embodiments.

As used herein, the term “cocoa” includes material produced by pulverizing cacao nibs after lipid removal and contains 10-22% cacao lipid by weight. Cocoa may include further optional ingredients to alter functionality, such as alkali ingredients (ammonium, potassium or sodium bicarbonate potassium and sodium hydroxide, magnesium carbonate or oxide, used as solid materials or in aqueous solutions. This also includes breakfast cocoa and low-fat cocoa as described in the CFR at 163.112 and 163.114 respectively. The term cocoa encompasses cocoa extracts. An “extract,” as used herein, refers to the concentration of active ingredients, flavors, and odorous molecules from a raw material or raw materials. In some embodiments, the raw materials may include cocoa or cacao. Often, the extract is extracted by percolation of the raw material with an organic solvent (for example, ethanol) and water. A cocoa extract as described herein may comprise an extract from any part of the cocoa plant, such as the cocoa bean.

The cocoa may be natural cocoa or alkalized cocoa. Naturalized cocoa would be expected to have a higher content of polyphenols than alkalized cocoa. The alkalized cocoa can be alkalized using potassium carbonate, sodium carbonate, or other bases.

As used herein, the term “cold gelation” refers to a process where dairy proteins, including casein and whey, self-assemble and pack to form gels at low temperatures, such as below 20 °C, or below 10 °C, or below 5 °C, or at typical refrigeration temperatures of from about 2 °C to about 4 °C. In some cases, cold gelation can be strengthened or made more prevalent by the addition of specific ingredients, such as calcium-containing salts or acidifying agents, which interact with the dairy proteins to cause the dairy proteins to aggregate and form a gel network.

As used herein, the term “calcium-binding chelator compound,” “calcium-chelating salt,” and the like, refers to any anionic or molecular compound that preferentially forms an interaction with divalent calcium (Ca²⁺) in the solution phase of the beverage. In some embodiments, the interaction comprises one or more ionic bonds. In some embodiments, the interaction comprises one or more covalent bonds. In some embodiments, the interaction comprises one or more non-covalent interactions. Generally, the calcium-binding chelator can preferentially bind the calcium and sequester it from other components of the beverage, including the milk protein components, including casein. Non-limiting examples of suitable calcium-binding chelator compounds according to some embodiments of the present disclosure include food grade phosphates (Lampila, 2013) (including Monosodium phosphate, Disodium phosphate, Trisodium phosphate, Monopotassium phosphate, dipotassium phosphate, tripotassium phosphate, monocalcium phosphate, dicalcium phosphate, tricalcium phosphate), pyrophosphates (including sodium acid pyrophosphate, tetrasodium pyrophosphate, tetrapotassium pyrophosphate) and polyphosphates (including sodium tripolyphosphate, potassium tripolyphosphate), citrates (for example, as described in Hoyt and Gewanter, 1992) (including monosodium citrate, disodium citrate, trisodium citrate, monopotassium citrate, dipotassium citrate, tripotassium citrate, mono calcium citrate, dicalcium citrate, tricalcium citrate), organic acids (for example, as described in Rauser, 1999) (including Malic acid, acetic acid and citric acid), uronic acids (for example, as described in Debon and Tester, 2001, Filipiuk et al., 2005), aminopolycarboxylates (for example, as described in Asemave, 2018, Pinto et al., 2014) (including ethylenediaminetetraacetic acid (EDTA) and diethylenetriaminepentaacetic acid (DTPA), and proteins/peptides (for example, as described in Tian et al., 2021).

As used herein, the term “hydrocolloid” refers to a range of polymers comprising polysaccharides and proteins, that alter one or more physical properties of aqueous matrices, such as by formation of gels, thickening, emulsification, increasing water retention, and stabilization of the matrices by dispersing solid particles.

As used herein, the term “micelle,” “micellar” and the like refers to a spherical colloidal particle formed by amphiphilic molecules and surfactants in which the hydrophilic regions face the polar solvent, and the hydrophobic regions face the nonpolar solvents.

As used herein, the term “self-assembly” refers to the process by which a pre-existing disorganized system rearranges forming an organized structure or matrix, due to specific interactions between molecules, and the components without an outside force. This phenomenon is observed in, for example, colloids, hydrocolloids, micelles, emulsions, protein aggregates, protein gels, and a combination thereof.

As used herein, the term “sweetener” refers to any suitable additive for sweetening a beverage. The sweetener may be a natural sweetener or an artificial sweetener. The form of the sweetener is not particularly limited, and the skilled artisan will be familiar with the use of sweeteners in consumer beverages. Non-limiting examples of suitable sweeteners include sugar, sucrose, glucose, fructose, corn syrup, high-fructose corn syrup, maple syrup, honey, monk fruit extract, allulose, acesulfame potassium, aspartame, saccharin, Splenda™, Sucralose™, and stevia leaf extract.

As used herein, the term “preservative” refers to any suitable additive for extending the consumable period of a beverage, including by protecting the beverage against microbial growth, including bacterial and fungal growth. The form of the preservative is not particularly limited. Non-limiting examples of preservatives according to some embodiments include benzoates, sorbates.

As used herein, the term “flavorant” refers to any suitable additive for modifying or improving the flavor of a beverage. The form of the flavorant is not particularly limited. Non-limiting examples of flavorants according to some embodiments include natural and artificial flavors utilizing specific molecular compound classes such as flavonoids, alcohols, esters, pyrazines, ketones, aldehydes, fatty acids, lactones, peptides and other aromatic compounds to mimic or enhance flavors within a product (for example, as described in Henrique, 2020). In some embodiments, the flavorant includes vanilla. In some embodiments, the flavorant includes a peach or strawberry flavored flavorant. Other non-limiting examples of flavorants and/or flavorant flavors include cherry, grape, watermelon, fruit punch, banana, orange, lemon, lime, and lemon-lime. The type of flavorant is not particularly limited and the skilled person will be familiar with the use of flavorants in beverage compositions. The flavorant of some embodiments is a dry ingredient, such as a dried extract or a spice. The spice of some embodiments comprises chile powder, chiles, pepper, or capsaicin. The flavorant of some embodiments is a wet ingredient, such as a liquid or syrup. The flavorant may include a fruit extract, such as a fruit syrup. The flavorant may be naturally flavored or artificially flavored.

As used herein, the term “ultrafiltration” refers to a process in which a liquid is passed through a series of semipermeable membranes with varying pore sizes and pressure applications that allows the permeation of water and smaller molecules, thus concentrating the larger molecules.

As used herein, the term “homogenization” refers to a process in which a liquid, or mixture of liquids, is subjected to a high-pressure mixing. The homogenization process physically stabilizes the product and enhances emulsification.

As used herein, the term “viscosity” refers to a property of fluids that measures its resistance to change shape, or flow. Viscosity can be measured in different ways. An exemplary way of measuring the viscosity is by using a viscometer (rotational, capillary, or falling ball) (Cheng et al., 2022, Bhattad, 2023). The rotational viscometer comprises a rotating spindle rotated at a constituent speed. This spindle measures the viscosity by analyzing the torque requirement needed to maintain the constant speed stated previously. Another method for testing viscosity is by utilization of a rheometer, which allows one to measure both viscosity and viscoelasticity. The skilled person will be familiar with methods of measuring viscosity in beverage compositions.

Properties including viscosity and mouthfeel of high-protein nutritional beverages can undergo noticeable changes with temperature changes, influencing the overall sensory experience of the consumer. When chilled, these beverages often exhibit a thicker viscosity, enhancing their creamy texture and perceived richness. One could posit that ice-cold high-protein beverages may resemble ice cream milk shakes, a connection that enhances their appeal among consumers. Conversely, when dairy-based drinks are served warm, the viscosity tends to decrease, sometimes significantly, creating a lighter, more fluid mouthfeel that may go against habitual sensory preferences and cultural conditioning. Warm high-protein dairy drinks can be perceived as having a different taste and texture, which may not appeal to everyone. Understanding and controlling these temperature-dependent changes allows for the optimization of the drinking experience based on personal preference and desired sensory attributes, ensuring high-protein beverages are enjoyed to their fullest potential across different serving temperatures.

It is known that high-protein dairy solutions may coagulate with the addition of different salts (Goulder and Harte, 2022, Perez et al., 2022), altering of pH (Mejares et al., 2024, Nicolai and Chassenieux, 2021, Lucey et al., 2022, Tari et al., 2021), extensive heating (Nicolai and Chassenieux, 2021), and when kept cold for extended periods of time (Goulder and Harte, 2022), creating gels through various mechanisms, where the gels can have different matrices and/or structures. The mechanisms that create these properties are complex and not well understood, despite being an active area of scientific research.

When gelation is caused by a reduced temperature, it can also be referred to as cold gelation. The cold gelation phenomenon is influenced by several properties including pH, ionic strength, and the concentration of salts or gelling agents (Goulder and Harte, 2022). Cold gelation is advantageous for creating dairy products with unique textures and stability, such as yogurts, desserts, and certain types of cheese, while preserving the nutritional quality and delicate flavors that might be compromised by heat treatment. However, cold gelation can be highly undesirable with high-protein nutritional beverages that are typically consumed cold, including at or near typical refrigeration temperatures. In some applications, it is desirable that the beverage have little or no noticeable physicochemical changes, such as texture or viscosity changes, with variations of temperature across a typical drinking range. For example, a beverage that is more fluid-like at room temperature than from the refrigerator may confound a consumer's expectation of a standard drinking experience or may lead the consumer to believe that the beverage may be defective.

Many natural ingredients, including cocoa (Hopfer et al., 2022, Dalabasmaz et al., 2023, Accardo et al., 2023) and coffee (Messery et al., 2020, Rashidinejad et al., 2021), contain components that can form significant interactions with dairy proteins, such as volatile flavor components, polyphenols, and acids. These ingredients can disturb the structure or self-assembly of dairy proteins, including caseins (the primary proteins in milk) through a combination of physical and chemical mechanisms, affecting the stability, structure, functionality, texture, and flavor of the dairy product. Macromolecules, including polyphenols, including one or more of the polyphenols naturally present in cocoa and coffee, can interact with caseins, and/or compounds including divalent calcium (Ca²⁺) physically or chemically associated with caseins in the beverage, to act as a gelling agent (Quan et al., 2019). There are several different ways in which macromolecules can interact with dairy proteins, including casein and casein micelles, a few of which are summarized below.

1. Hydrophobic interactions: Both cocoa and coffee contain hydrophobic compounds, such as theobromine in cocoa and caffeine in coffee, which can interact with the hydrophobic regions of casein micelles (Langerijt et al., 2023 Ashwar and Gani, 2021, Chen et al., 2022,). In these interactions, the aromatic benzenoid rings of the polyphenolic groups can interact with the hydrophobic regions of casein and whey, thus complexing together (Langerijt et al., 2023). This interaction can improve emulsifying abilities of the casein, change their secondary and tertiary structures, and can promote different functionalities of casein (Chen et al., 2022). Thus, these interactions can lead to changes in the structural organization and functionality of casein, and casein and whey systems, potentially affecting the texture and stability of the dairy products with polyphenolic compounds (Langerijt et al., 2023).

2. lonic and proton-exchange interactions: Coffee and cocoa are both slightly acidic, which can alter the localized pH of the dairy system. Caseins are sensitive to local and bulk pH changes, and a decrease in pH can cause caseins to precipitate or gel (Li and Zhao, 2019), leading to the formation of a firmer texture or curdling in some cases. The amount of calcium present within the casein micellular matrix and serum is also related to the pH of the system. As the system's pH decreases, some of the casein micelle dissociate, increasing calcium within the serum fraction (Li and Zhao, 2019, Koutina et al., 2014, Zhao and Corredig, 2016). As the pH of the system increases, much of calcium remains within the micelle (Koutina et al., 2014, Zhao and Corredig, 2016). Without intending to be bound by the theory, it is believed that such a shift in free calcium could be one of the causes for the rate of gelation variations at different pHs. Thus, the addition of pH-modifying ingredients can cause a change to the gelation rate.

3. Polyphenol-protein interactions: many beverage ingredients, including cocoa, tea and coffee, are rich in polyphenols, which can bind to amino acids of proteins, including caseins, through electrostatic, hydrogen bonding, and/or hydrophobic interactions. This binding can affect the solubility and aggregation state of caseins, influencing the mouthfeel and stability of the final product. Polyphenols can also contribute to the browning reactions during heating, which may alter the visual and sensory properties of the dairy product. Polyphenols can also interact with proteins through covalently linking interactions altering the protein systems' matrix and functionality. It has been suggested that, when proteins and polyphenols interact through covalent or non-covalent interactions, an increased gel formation tendency can be observed (Quan et al., 2019, Staszewski et al., 2012, Bayraktar et al., 2018) Some studies determined that tea polyphenols have a high affinity for bonding to whey proteins and kappa casein and greatly accelerate and promote gel formation (Statszewski et al., 2011, Staszewski et al., 2012), and another study demonstrated an enhanced gel formation by interacting gallic acid with milk proteins (Bayraktar et al., 2019). These studies demonstrate the potential of polyphenol and protein interactions to promote gelation, thus altering the gel formation structures observed without phenolic compounds.

4. Flavor-binding interactions: hydrophobic domains in caseins can interact with hydrophobic regions in flavor compounds, which can help to stabilize volatile flavors in cocoa and coffee. This can enhance the flavor profile of dairy products by providing a more prolonged and balanced release of coffee and cocoa flavors.

Therefore, the interaction of ingredients commonly present in beverages, including cocoa and coffee and extracts thereof, with casein micelles can enhance the sensory attributes of the beverages, and alter the matrix of the product leading to unique structures, textures, and flavors. However, careful formulation is required to ensure the desired stability and mouthfeel of the final product. Moreover, this is especially the case if the beverage requires heat treatment for sterilization, as the heat treatment itself can induce various changes in the beverage components and the interactions between them.

The power law model of viscosity is a mathematical model that describes the flow behavior of non-Newtonian fluids. Non-Newtonian fluids are fluids that do not have a constant viscosity as a function of varying stress. According to this model, the viscosity of a non-Newtonian fluid changes with the rate of shear strain, making it a useful variable for characterizing fluids whose resistance to flow varies under different conditions, including different temperature conditions. The power law model is expressed by the equation t=Kin-1, where t is the shear stress, y is the shear rate, K is the consistency index (a measure of the fluid's viscosity), and n is the flow behavior index. If n=1, the fluid behaves as a Newtonian fluid with constant viscosity. If n<1, the fluid is shear-thinning, meaning its viscosity decreases with increasing shear rate. Conversely, if n>1, the fluid is shear-thickening, where its viscosity increases with shear rate.

The power law viscosity model is extensively used in the food processing industry, because it can provide useful insights about the underlying microstructures of various complex fluids that are difficult to resolve using other methods. For example, viscosity can capture subtle physicochemical structural, differences including differences in a distribution of peptide chains between micellar and solvated form, extent of an ordered versus disordered hierarchical structure (micelles, gels, colloids, nanosheets, etc.). In some cases, the different macromolecular structure may arise not from different composition of the beverage, but from differences in the formulation process of the complex fluid. It is well known that the order of addition of ingredients, the temperature and duration of heat treatment, the extent and duration of mixing, and many other formulation details can affect the ultimate structure of the final beverage. For these reasons, the power law viscosity model is widely used to characterize beverages having multiple components that interact in complex chemical and physical ways.

Zero shear viscosity is the viscosity of a fluid measured at an extremely low shear rate, effectively representing the fluid's viscosity when it is at rest or under minimal flow conditions. This parameter is highly relevant to the mouthfeel of food and beverages, influencing the sensory experience and perception of texture. Zero shear viscosity contributes to the initial thickness and body of a product when it first enters the mouth. Products with higher zero shear viscosity tend to feel thicker and creamier, which is often desirable in dairy products. It affects how well a product coats the mouth and tongue, providing a sense of richness and fullness. This property is crucial for dairy-based products like yogurts and ice creams, where a smooth and uniform mouthfeel is important for consumer satisfaction. The viscosity at zero shear plays a crucial role in the release of flavors. Higher viscosity can slow down the release of flavors, leading to a more prolonged and sustained taste experience, while lower viscosity can result in a quicker, more immediate flavor burst. Therefore, mouthfeel is strongly correlated with zero shear viscosity and can significantly impact the overall sensory appeal and acceptability of a product. It contributes to the perceived quality and indulgence of a product, making it an essential consideration in food formulation and product development.

High-protein nutritional milk shakes are formulated with different objectives than medical nutritional products. Most medical nutrition products are formulated to meet specific dietary needs related to specific medical conditions, recovery, or malnutrition. Medical nutrition products are also developed to satisfy the needs of patients with chronic illnesses, elderly individuals with specific dietary needs or restrictions, or people recovering from medical procedures. In addition, some medical nutrition products are formulated with properties that make them adept to conditions that make easier to ingest, either for textural reasons (e.g. conditions related to swallowing) or flavor reasons (e.g. conditions related to nausea). On the other hand, high-protein nutritional milk shakes are often formulated with consumer enjoyment as an important objective. It is envisioned that these beverages will be consumed by fitness enthusiasts, people looking to increase their protein intake, and those seeking weight management or muscle maintenance. These kinds of beverages will most likely be enjoyed at different temperatures, over ice, room temperature, sipped slowly, drank fast, etc., and the consumer will have high organoleptic expectations in all the variety of settings. Therefore, a formulation strategy that maintains constant mouthfeel and texture across different temperatures may be beneficial to the performance and acceptance of high-protein nutritional beverages.

Some embodiments of the present disclosure are directed to a milk protein beverage. The milk protein beverage may be formed, at least in part, using milk protein powder. The milk protein beverage may be a high protein filtered milk beverage. In some embodiments, the beverage includes milk protein, one or more polyphenol-containing agents, and one or more calcium-binding agents.

In some embodiments, the milk protein beverage has a viscosity difference across a temperature range of from about 2 °C to about 30 °C of 150 cP or less, 140 cP or less, 130 cP or less, 120 cP or less, 110 cP or less, 100 cP or less, 90 cP or less, 80 cP or less, 70 cP or less, 60 cP or less, 50 cP or less, 40 cP or less, 30 cP or less, 20 cP or less, or 10 cP or less. As used herein, the term “viscosity difference” means the difference of the viscosity of the beverage at a first temperature and the viscosity of the beverage at a second temperature. The first temperature and the second temperature can be any temperatures in the range of from about 2 °C to about 30 °C. In some embodiments, the first temperature can be 2 °C and the second temperature can be 30 °C, such that the difference between the beverage viscosity at 2 °C and the beverage viscosity at 30 °C is less than, for example, 150 cP.

In some embodiments, the milk protein beverage has a viscosity difference across a temperature range of from about 2 °C to about 30 °C of 50% or less, such as 40% or less, 30% or less, 20% or less, 10% or less, or 5% or less.

In some embodiments, the milk protein beverage has a viscosity of about 150 cP or less, or 140 cP or less, 130 cP or less, 120 cP or less, 110 cP or less, 100 cP or less, 90 cP or less, 80 cP or less, 70 cP or less, 60 cP or less, 50 cP or less, 40 cP or less, 30 cP or less, or 20 cP or less, across a temperature range of from about 2 °C to about 30 °C.

In some embodiments, the viscosity remains stable for a period of at least 30 days, or at least 60 days, or at least 90 days, or at least 6 months, or at least 1 year, or at least 2 years, beginning when the beverage is formulated. As used herein, the term “stable” means that the viscosity remains within the specified range, such as about 150 cP or less, or has a difference within a specified percentage, such as 50% or less, for the entire time period specified. For example, in some embodiments the viscosity may remain in the range of about 150 cP or less for at least 30 days, or at least 60 days, or at least 90 days, or at least 6 months, or at least 1 year, or at least 2 years.

In some embodiments, the milk protein beverage, such as the high protein filtered milk beverage, includes a hydrocolloid as a viscosity modifier.

In some embodiments, the milk protein beverage comprises ultrafiltered milk. The ultrafiltered milk may have a concentration of from 50% w/w to 99% w/w, such as from 50-55% w/w, from 55-60% w/w, from 60-65% w/w, from 65-70% w/w, from 70-75% w/w, from 75-80% w/w, from 80-85% w/w, from 85-90% w/w, from 90-95% w/w, or from 95-99% w/w of the milk protein beverage.

In some embodiments, the milk protein has a concentration of from about 1% to about 20% w/w of the beverage. In some embodiments, the milk protein may have a concentration of from about 1% to about 2% w/w, from about 2% to about 4% w/w, from about 4% to about 6% w/w, from about 6% to about 8% w/w, from about 8% to about 8.5% w/w, or from about 8.5% to about 9% w/w, or from about 9% to about 9.5% w/w, or from about 9.5% to about 10% w/w. In some embodiments, the milk protein may have a concentration of from about 5% to about 6% w/w, or from about 4% to about 6% w/w, or from about 3% to about 6% w/w. In some embodiments, the milk protein may have a concentration of from about 10-12% w/w, or from about 12-14% w/w, or from about 14-16% w/w, or from about 16%-18% w/w, or from about 18% to about 20% w/w.

In some embodiments, the milk protein comprises casein. The milk protein may comprise from about 50% to about 100% w/w casein. In some embodiments, the milk protein consists essentially of casein. As used herein, the term “consists essentially of” means that about 90% or more, such as 95% or more, 98% or more, 99% or more, 99.5% or more, 99.8% or more, or 99.9% or more, of the milk protein comprises casein. In some embodiments, the milk protein consists of casein.

According to some embodiments, the casein comprises micelles. In some embodiments, from about 50% to about 100% of the casein in the beverage is in a micellar form.

In some embodiments, the remainder of the milk protein in the beverage that is not dairy casein proteins comprises dairy whey proteins.

In some embodiments, the milk protein beverage comprises one or more polyphenol-containing agents having a concentration of from 0.05% to about 2%. The concentration of the one or more polyphenol-containing agents can be from 0.05% to 1%, 1.0 to 1.5%, or 1.5 to 2%. In some embodiments, the one or more polyphenol-containing agents includes cocoa or a cocoa extract. In some embodiments, the cocoa extract is a cocoa bean extract. In some embodiments, the cocoa or cocoa extract has a concentration of from about 0.05% w/w to about 2% w/w in the beverage. In some embodiments, the cocoa is an alkalized cocoa.

In some embodiments, the milk protein beverage comprises one or more polyphenol-containing agents having a concentration of from 2% to 99%. The concentration of the one or more polyphenol-containing agents can be from 2 to 5%, 5 to 10%, 10 to 20%, 20 to 30%, 30 to 40%, 40 to 50%, 50 to 60%, 60 to 70%, 70 to 80%, 80 to 90%, 90 to 95%, or 95 to 99%.

In some embodiments, the one or more polyphenol-containing agents includes coffee or a coffee extract. The coffee or coffee extract in the beverage may have a concentration of from about 0.05% w/w to about 5% w/w, or from about 0.05% w/w to about 50% w/w, or from about 50% w/w to about 90% w/w or 100% w/w. In some embodiments, the coffee or coffee extract is a decaffeinated coffee, decaffeinated coffee extract, or a decaffeinated soluble coffee.

In some embodiments, the one or more polyphenol-containing agent includes an espresso-based coffee or extract thereof. The espresso-based coffee can include a mocha, latte, cappuccino, americano, or any other espresso-based beverage flavor. In some embodiments, the one or more polyphenol-containing agents includes fruit, a fruit extract, or a fruit puree. The fruit puree may have a concentration of from about 0.01% w/w to about 45% w/w of the beverage.

In some embodiments, the one or more polyphenol-containing agents includes berries, such as blueberries, raspberries, strawberries, blackberries, and/or cranberries. In some embodiments, the one or more polyphenol-containing agents includes apples, pears, grapes, olives, broccoli, spinach, kale, onions, garlic, nuts and seeds including peanuts and peanut butter, flaxseeds, walnuts, almonds, hazelnuts, pecans and sesame seeds, legumes including soybeans, lentils, chickpeas and black beans, grains including oats, whole wheat and brown rice, spices and herbs including cinnamon, cloves, curry, turmeric, ginger, oregano and/or rosemary, or any extract thereof. In some embodiments, the polyphenol-containing agent includes black olives, green olives, or olive oil.

In some embodiments, the polyphenol-containing agent includes soy, such as soy flour, tempeh, soy yogurt, soy tofu, and soy milk. Some embodiments can also contain oat or oat derivates, such as oat powder, oat flour, hydrolyzed oat powder, oat extract.

In some embodiments, the one or more polyphenol-containing agents includes a beverage or beverage extract such as tea, including green tea and black tea, red wine.

In some embodiments, the beverage contains one or more bioactive compounds, including but not limited to theobromine, caffeine, nicotine, taurine, testosterone, lactobacilli or other microorganisms, yeasts, flavonoids including quercetin, catechin, or anthocyanin, phenolic acids including caffeic acid or chlorogenic acid, terpenoids, steroids, alkaloids, vitamins and minerals, including Vitamins A, B, C, D, E, magnesium, fatty acids including omega-3 or omega-6 fatty acids, or any other bioactive compounds. The term “bioactive compound” as used herein refers to any naturally occurring or synthetic substance that exerts a beneficial effect on human or animal health when consumed in an appropriate quantity. The beneficial effect may take the form of a measurable effect on a biological system, such as influencing cellular function, physiological processes, or biochemical pathways. Bioactive compounds sourced from natural sources are generally secondary metabolites produced by a plant, microorganism, or animal, and possess biological activity.

In some embodiments, the milk protein beverage may comprise lactose. The lactose may be residual lactose from ultrafiltered milk. The beverage may also comprise a mixture of glucose and galactose. Glucose and galactose can be byproducts of lactase hydrolysis of lactose, and can be present in lactose free products.

In some embodiments, the pH of the beverage is in a range of from about 6 to about 8.

In some embodiments, the one or more calcium-binding chelator agent is present in the beverage at a concentration of from about 1 mM to about 30 mM, such as from about 1 mM to about 2 mM, about 2 mM to about 4 mM, about 4 mM to about 6 mM, about 6 mM to about 8 mM, about 8 mM to about 10 mM, about 10 mM to about 12 mM, about 12 mM to about 14 mM, about 14 mM to about 15 mM, about 15 mM to about 20 mM, about 20 mM to about 25 mM, or about 25 mM to about 30 mM. In some embodiments, the one or more calcium-binding chelator agent has a concentration from about 0.01% w/w to 2% w/w.

The calcium-binding chelator agent may be selected from one or more of a phosphate, a monophosphate, a polyphosphate, or a citrate. In some embodiments, the calcium-binding chelator agent is a sodium salt or a potassium salt of a phosphate, a monophosphate, a polyphosphate, or a citrate. In some embodiments, the calcium-binding chelator agent comprises di-potassium phosphate.

In some embodiments, the calcium-binding chelator salt may reduce or eliminate a temperature-dependent viscosity increase of the beverage or reduce or eliminate a cold-gelation effect of the beverage. Without intending to be bound by the theory, it is believed that the polyphenol-containing agent in the beverage can act as a gelling agent by causing the casein micelles to clump together, forming a network of casein micelles. The gelling interaction between the polyphenol-containing agent and the casein micelles may be mediated by divalent calcium (Ca²⁺) that may be present in the beverage. The gelling interaction may be a cold-gelation effect. The gelling interaction may contribute to an increase of viscosity that is temperature-dependent: for example, the viscosity of the beverage may increase with decreasing temperature. The increasing viscosity may or may not include the formation of a gel. Without intending to be bound by the theory, the calcium-binding chelator agent may sequester Ca²⁺ and reduce the interactions between the polyphenol-containing agent, the casein, and the Ca²⁺ which cause, or contribute to, cold gelation or temperature-dependent viscosity increase.

In some embodiments, the milk protein beverage of the present disclosure does not comprise a polyphenol-containing agent. Without intending to be bound by the theory, in these embodiments it is believed that the interaction between casein and Ca²⁺ contributes to the cold gelation or to the temperature-dependent viscosity increase. For example, non-micellar casein, such as individual solvated casein molecules, may form temperature-dependent “bridges” between casein micelles to form an aggregated network that increases the viscosity and/or induces cold gelation, and this bridging effect may be mediated by Ca²⁺ ions, such as through negatively-charged amino acids on casein. Without intending to be bound by the theory, the calcium-binding chelator agent of these embodiments may disrupt the linkage of micelles by sequestering available Ca²⁺ ions out of the network, making the ions unavailable to form the temperature-dependent bridging interactions and thus reducing viscosity increase or cold-gelation. In some embodiments, adding a first amount of calcium-binding chelator compound decreases viscosity, but adding a second higher amount of the calcium-binding chelator compound increases the viscosity. Thus, in some embodiments, a “U-shaped” behavior of viscosity as a function of chelator concentration is present. In some embodiments, the U-shaped behavior is time-dependent, such that with the second amount of the calcium-binding chelator compound, the increase in viscosity is not observed immediately, but can be observed after a certain amount of time following formulation of the milk protein beverage, such as after two weeks, after four weeks, after six weeks, after eight weeks, after three months, or after six months.

In some embodiments of the present disclosure, the milk protein beverage is a Newtonian fluid. A flow behavior index of the milk protein beverage may be in a range from about 0.8 to about 1.1. In some embodiments, a shear stress of the beverage is proportional to a shear rate of the beverage. In some embodiments, the flow behavior is in a range from about 0.8 to about 1.1 and the shear stress is proportional to the shear rate.

In some embodiments, the beverage comprises a fat. In some embodiments, the fat is in the form of an oil, including an emulsified oil, a butterfat, or a cream. In some embodiments, the oil or emulsified oil includes one or more of vegetable oil, canola oil, olive oil, sunflower oil, peanut oil, and avocado oil. The fat content of the beverage according to some embodiments is in a concentration range of from about 0.01% w/w to about 3% w/w.

In some embodiments, the milk protein beverage comprises one or more of a sweetener, a preservative, or a flavorant. The use of sweeteners, preservatives, and flavorants will be known to the skilled artisan, and, for example, may include any of the non-limiting examples of sweeteners, preservatives, and flavorants described herein.

In some embodiments, the milk protein beverage comprises sea salt. The beverage may comprise vitamins. Non-limiting examples of vitamins present in the beverage include Vitamins A, B, C, D, E, and K. Preferred embodiments include Vitamin A and/or Vitamin D. In some embodiments, a Vitamin A and D mixture is used in the formation of the beverage.

In some embodiments, the milk protein beverage of the present disclosure includes: from about 8% to about 10% milk protein, the milk protein comprising casein, at least a portion of the casein being in the form of casein micelles; from about 0.05% w/w to about 2% w/w cocoa or cocoa extract; and from about 1 mM to about 15 mM calcium-binding chelator compound. In some embodiments, the beverage has a viscosity of about 150 cP or less in a temperature range of from about 2 °C to about 30 °C. In some embodiments, the beverage has a viscosity difference of about 150 cP or less across a temperature range of from about 2 °C to about 30 °C. In some embodiments, the viscosity and/or the viscosity difference remains at about 150 cP or less, or at about 40 cP or less, across a temperature range of from about 2 °C to about 30 °C for a period of at least 30 days, or at least 60 days, or at least 90 days, or at least 6 months, or at least 1 year, or at least 2 years, after formation of the beverage.

The milk protein beverage may be provided inside a container. The form of the container is not particularly limited. Non-limiting examples of containers include cans, bottles, and pouches. The container may be aluminum, stainless steel, glass, plastic, or any other material suitable for packaging the beverage as a consumer product.

In some embodiments, the milk protein beverage comprises a spray dried beverage, such as a spray dried coffee. In some embodiments, the milk protein beverage comprises a cold brew, such as a cold brew coffee or a cold brew tea.

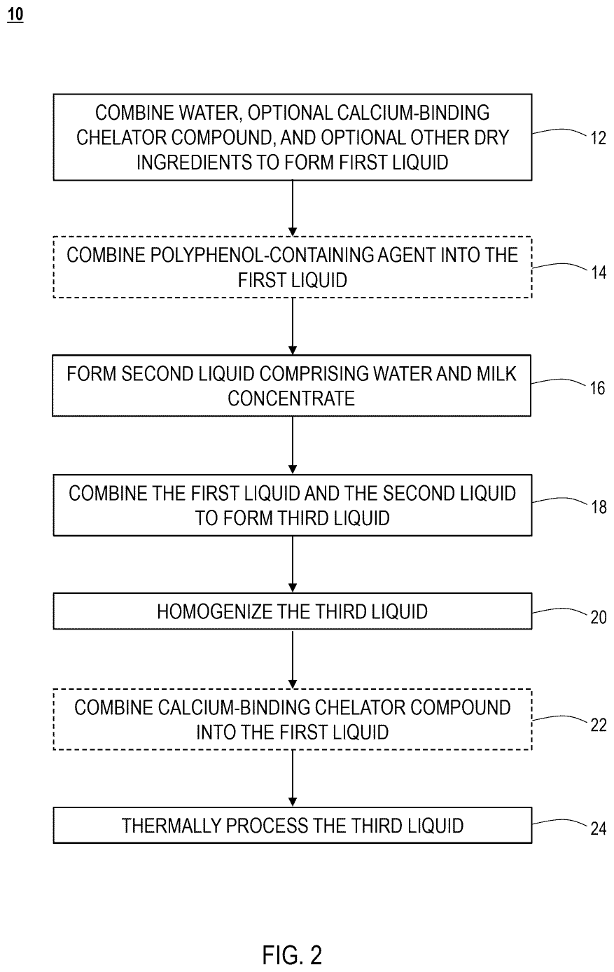

Some embodiments of the present disclosure are directed to a method of producing a milk protein beverage. The milk protein beverage may include any of the high-protein filtered milk beverages described herein. In some embodiments, the method may comprise a method 10 as illustrated schematically in the flow chart of FIG. 2. In some embodiments of method 10, at operation 12, a first liquid is formed by mixing water and optionally one or more calcium-binding chelator compounds. The one or more calcium-binding chelator compounds may include di-potassium phosphate. The one or more calcium-binding chelator compounds of some embodiments, such as di-potassium phosphate, may have a concentration of from 0.05% w/w to about 0.5% w/w. In some embodiments of operation 12, one or more other ingredients are also mixed in the first liquid. The other ingredients may include other dry ingredients. For example, the other ingredients may include an antifoam agent and/or pectin, each independently having a concentration of 0.25% w/w or less. In some embodiments, the antifoam agent and/or pectin are added to the water and mixed before any further other dry ingredients are added to the first liquid, and/or before one or more polyphenol-containing agents are added to the first liquid. Other ingredients that may be mixed in the first liquid include sweeteners, such as sucralose, monk fruit, and/or acesulfame potassium. The other ingredients may also include salt, for example sea salt, or a suitable salt substitute. The other ingredients of the first liquid may also include vitamins, such as an A and D vitamin mix. The first liquid may be mixed in a shear tank. The first liquid may be mixed at an elevated temperature, such as the dry ingredients may be added to water at an elevated temperature, such as a water temperature in a range of from about 150 °F to about 250 °F.

In some embodiments, at optional operation 14, one or more polyphenol-containing agents is mixed into the first liquid. The one or more polyphenol-containing agents may include cocoa or cocoa extract, coffee or coffee extract, or any other polyphenol-containing agent, including but not limited to any of the polyphenol-containing agents described herein.

Referring to FIG. 2, in some embodiments, at operation 16, a second liquid is formed. The second liquid may comprise water and a milk concentrate. In some embodiments, the milk concentrate comprises an ultrafiltered milk. In some embodiments, the milk concentrate comprises a filtered milk that is not ultrafiltered. In some embodiments, the milk concentrate is formed from a milk powder or a milk blend. In some embodiments, the milk concentrate comprises a milk protein concentrate (MPC). In some embodiments, the milk concentrate comprises a milk protein isolate (MPI), Microfiltered Milk Protein Concentrates (MMPC), Microfiltered Milk Protein Isolates (MMPI), or Micellar Casein Concentrates (MCC), or Micellar Casein Isolates (MCI). The MPC may be MPC 20-50%, MPC 51-70%, MPC 71-89%, or higher. The milk concentrate may also be a combination of different forms of milk concentrate, such as a combination of any of the milk concentrate forms provided herein. While preferred embodiments of the present disclosure utilize cow milk, other milks, including soy milk and goat milk, are envisioned herein in some embodiments. Synthetic cow milks (those reproducing the composition of cow milk but synthetically produced) are contemplated herein, in some embodiments.

In addition to milk proteins, the milk concentrate may have additional ingredients present, non-limiting examples including lactose, fat, moisture, carbohydrates, microbiological agents, and ash.

In some embodiments, the milk concentrate of the second liquid consists of, or consists essentially of, an ultrafiltered milk. In some embodiments, the second liquid has additional ingredients in addition to the milk concentrate, for example other wet ingredients. In some embodiments, the second liquid comprises, or consists essentially of, a milk concentrate, water, and cream, such as an ultrafiltered milk, water, and cream. When present, the water in the milk concentrate may have a concentration of about 50% w/w or less, such as about 30% w/w or less, 20% w/w or less, 10% w/w or less, or 5% w/w or less.

In some embodiments, at operation 18 of method 10, the first liquid and the second liquid are combined to form the third liquid. In some embodiments, the combined first and second liquids are mixed again to properly disperse all the ingredients. The combined first and second liquids may be heated before further operations of method 10, the heating comprising a temperature of from about 140 °F to about 170 °F.

As shown in operation 20 of method 10, in some embodiments the third liquid is homogenized using a high-pressure homogenization process. The total pressure of the homogenization may be from about 1000 psi to about 5000 psi, or from about 2000 psi to about 5000 psi. In some embodiments, the homogenization is performed in two stages. The first stage may have a lower pressure, such as about 2000 psi, and the second stage may have an additional pressure, such as about 500 psi.

In some embodiments, at optional operation 22, the one or more calcium-binding chelator compound is added to the third liquid after homogenization 20. Without limitation, the addition of the one or more calcium-binding chelator compound can occur at any step during method 10.

In some embodiments, after the homogenization, one or more flavorants are added to the third liquid. The one or more flavorants may comprise vanilla. The one or more flavorants may comprise strawberry, such as a strawberry or strawberry-flavored syrup. The one or more flavorants may comprise peach, such as a peach or peach-flavored syrup. In some embodiments, the flavorants comprise natural flavors.

In some embodiments, the flavorants can include a flavorant that is a coffee or espresso-based flavorant, or a flavorant that can accompany a coffee-based drink. For example, the milk protein beverage can comprise a mocha, latte, cappuccino, americano, or other espresso-based ingredient, or a flavorant that has a similar taste to any of these. The flavorant can comprise a cream flavorant, which can be natural or artificial.

In some embodiments, the flavorants, and/or the natural flavors, can be added in a concentration of less than about 20.0% w/w, such as less than about 10.0% w/w, 5.0% w/w, 2.0% w/w, 1.0% w/w, or 0.5% w/w.

In some embodiments, after the homogenization, additional water is added to the third liquid. For example, the additional water may be in an amount of 15% w/w or less.

In some embodiments, the flavorants, including natural flavors, and the additional water, are added before a thermal processing.

At operation 24 of method 10, in some embodiments, the third liquid is thermally processed. The thermal processing is performed in order to sterilize the third liquid. In some embodiments, the third liquid is placed into the product packaging before the thermal processing occurs, such that the beverage is thermally processed inside a closed container. For example, the closed container may comprise cans. The cans of some embodiments are aluminum cans. In some embodiments, the cans are 12 fluid oz. cans. In some embodiments, the cans have a maximum fill weight. For example, the maximum fill weight of the cans, including the 12 fluid oz. cans, may be in a range of from about 300 g to about 400 g. The 12 fluid oz. cans may have a maximum solid content of less than about 25%, such as less than about 20%, such as less than about 16%.

In some embodiments, the aluminum cans have other volumes. Non-limiting examples of suitable volumes include 6 fluid oz. cans, 8 fluid oz. cans, 10 fluid oz. cans, 12 fluid oz. cans, 16 fluid oz. cans, 20 fluid oz. cans, 1 L cans, 2 L cans, half-gallon cans, and gallon cans.

In some embodiments, the thermal processing of operation 24 is performed at a temperature of from about 105 °C to about 140 °C, and for a duration from about 4 minutes to about 15 minutes, or from about 4 minutes to about 10 minutes. In some embodiments, the minimum thermal processing temperature is about 123 °C. In some embodiments, a minimum thermal processing duration is about 7 minutes.

In some embodiments, the thermal processing 24 comprises retort processing.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

The entire content of the references provided below are incorporated by reference in their entireties.

### REFERENCES

Accardo, F., Prandi, B., Terenziani, F., Tedeschi, T., & Sforza, S. (2023). Evaluation of in vitro whey protein digestibility in a protein-catechins model system mimicking milk chocolate: Interaction with flavonoids does not hinder protein bioaccessibility. Food Research International, 169, 112888. https://doi.org/10.1016/j.foodres.2023.112888
Alexander, U.S. Patent Application Publication No. 2022/0400709
Asemave, K. (2018). Greener Chelators for Recovery of Metals and Other Applications. Organic & Medicinal Chemistry International Journal, 6(4). https://doi.org/10.19080/OMCIJ.2018.06.555694
Ashwar, B. A., & Gani, A. (2021). Noncovalent Interactions of Sea Buckthorn Polyphenols with Casein and Whey Proteins: Effect on the Stability, Antioxidant Potential, and Bioaccessibility of Polyphenols. ACS Food Science & Technology, 1(7), 1206-1214. https://doi.org/10.1021/acsfoodscitech. 1c00103
Barone, G., O'Regan, J., Kelly, A. L., & O'Mahony, J. A. (2022). Interactions between whey proteins and calcium salts and implications for the formulation of dairy protein-based nutritional beverage products: A review. Comprehensive Reviews in Food Science and Food Safety, 21(2), 1254-1274. https://doi.org/10.1111/1541-4337.12884
Bertenshaw, E. J., Lluch, A., & Yeomans, M. R. (2013). Perceived thickness and creaminess modulates the short-term satiating effects of high-protein drinks. British Journal of Nutrition, 110(3), 578-586. https://doi.org/10.1017/S0007114512005375
Bhattad, A. (2023). Review on viscosity measurement: devices, methods and models. Journal of Thermal Analysis and calorimetry, 148(14), 6527-6543. https://doi.org/10.1007/s10973-023-12214-0
Bonjour, J.-P. (2005). Dietary Protein: An Essential Nutrient For Bone Health. Journal of the American College of Nutrition, 24(sup6), 526S-536S. https://doi.org/10.1080/07315724.2005.10719501
Chen, L., Chen, N., He, Q., Sun, Q., Gao, M.-R., & Zeng, W.-C. (2022). Effects of different phenolic compounds on the interfacial behaviour of casein and the action mechanism. Food Research International, 162, 112110. https://doi.org/10.1016/j.foodres.2022.112110
Cheng, N., Barbano, D. M., & Drake, M. A. (2019). Effect of pasteurization and fat, protein, casein to serum protein ratio, and milk temperature on milk beverage color and viscosity. Journal of Dairy Science, 102 (3), 2022-2043. https://doi.org/10.3168/jds.2018-15739
Dalabasmaz, S., Toker, Ö. S., Palabiyik, I., & Konar, N. (2023). Cocoa polyphenols and milk proteins: covalent and non-covalent interactions, chocolate process and effects on potential polyphenol bioaccesibility. Critical Reviews in Food Science and Nutrition, 1-13. https://doi.org/10.1080/10408398.2023.2207661
Debon, S. J. J., & Tester, R. F. (2001). In vitro binding of calcium, iron and zinc by non-starch polysaccharides. Food Chemistry, 73(4), 401-410. https://doi.org/10.1016/S0308-8146 (00) 00312-5
De Kort et al., U.S. Pat. No. 10,264,806, issued Apr. 23, 2019.
El-Messery, T. M., Mwafy, E. A., Mostafa, A. M., El-Din, H. M. F., Mwafy, A., Amarowicz, R., & Ozçelik, B. (2020). Spectroscopic studies of the interaction between isolated polyphenols from coffee and the milk proteins. Surfaces and Interfaces, 20, 100558. https://doi.org/10.1016/j.surfin.2020.100558
Filipiuk, D., Fuks, L., & Majdan, M. (2005). Transition metal complexes with uronic acids. Journal of Molecular Structure, 744-747, 705-709. https://doi.org/10.1016/j.molstruc.2004.11.073
Ginty, F. (2003). Dietary protein and bone health. Proceedings of the Nutrition Society, 62(4), 867-876. https://doi.org/10.1079/PNS2003307
Goulder, D. M., & Harte, F. M. (2022). Prevention of low-temperature gelation in milk protein concentrates by calcium-binding salts. Journal of Dairy Science, 105(1), 32-39. https://doi.org/10.3168/jds.2021-20264
Hopfer, H., Riak, A. C., Roberts, R. F., Hayes, J. E., & Ziegler, G. R. (2022). Synergistic and antagonistic ingredient interactions as a sugar reduction strategy in chocolate milk. Journal of Sensory Studies, 37(5), e12770. https://doi.org/10.1111/joss. 12770
Kelleher, C. M., Aydogdu, T., Murphy, K. M., O'Mahony, J. A., Kelly, A. L., O'Callaghan, D. J., & McCarthy, N. A. (2020). The effect of protein profile and preheating on denaturation of whey proteins and development of viscosity in milk protein beverages during heat treatment. International Journal of Dairy Technology, 73(3), 494-501. https://doi.org/10.1111/1471-0307.12679
Kelleher, C. M., O'Mahony, J. A., Kelly, A. L., O'Callaghan, D. J., & McCarthy, N. A. (2018). Evaluation of Models for Temperature-Dependent Viscosity Changes in Dairy Protein Beverage Formulations During Thermal Processing. Journal of Food Science, 83(4), 937-945. https://doi.org/10.1111/1750-3841.14097
Kiliç Bayraktar, M., Harbourne, N. B., & Fagan, C. C. (2019). Impact of heat treatment and acid gelation on polyphenol enriched milk samples. LWT, 113, 108282. https://doi.org/10.1016/j.lwt.2019.108282
Koutina, G., Knudsen, J. C., & Skibsted, L. H. (2015). The effect of pH on calcium and phosphorus distribution between micellar and serum phase after enrichment of skim milk with calcium d-lactobionate. Dairy Science & Technology, 95(1), 63-74. https://doi.org/10.1007/s13594-014-0196-z
Lampila, L. E. (2013). Applications and functions of food-grade phosphates. Annals of the New York Academy of Sciences, 1301(1), 37-44. https://doi.org/10.1111/nyas. 12230
Li, Q., & Zhao, Z. (2019). Acid and rennet-induced coagulation behavior of casein micelles with modified structure. Food Chemistry, 291, 231-238. https://doi.org/10.1016/j.foodchem.2019.04.028
Liu, Y., Toro-Gipson, R. S. D., & Drake, M. (2021). Sensory properties and consumer acceptance of ready-to-drink vanilla protein beverages. Journal of Sensory Studies, 36(6), e12704. https://doi.org/10.1111/joss. 12704
Lucey, J. A. (2020). Chapter 16-Milk protein gels. In M. Boland & H. Singh (Eds.), Milk Proteins (Third Edition) (pp. 599-632). Academic Press. https://doi.org/10.1016/B978-O-12-815251-5.00016-5,
J. A., Wilbanks, D. J., & Horne, D. S. (2022). Impact of heat treatment of milk on acid gelation. International Dairy Journal, 125, 105222. https://doi.org/10.1016/j.idairyj.2021.105222
Magkos, F. (2020). Protein-Rich Diets for Weight Loss Maintenance. Current Obesity Reports, 9(3), 213-218. https://doi.org/10.1007/s13679-020-00391-0
Mattes, R. D., & Rothacker, D. (2001). Beverage viscosity is inversely related to postprandial hunger in humans. Physiology & Behavior, 74(4), 551-557. https://doi.org/10.1016/S0031-9384 (01) 00597-2
Mejares, C. T., Huppertz, T., & Chandrapala, J. (2024). Effect of calcium-sequestering salts and heat treatment on the rheological and textural properties of acid gels from blends of skimmed buffalo and bovine milk. International Dairy Journal, 149, 105840. https://doi.org/10.1016/j.idairyj.2023.105840
Menis-Henrique, M. E. C. (2020). Methodologies to advance the understanding of flavor chemistry. Current Opinion in Food Science, 33, 131-135. https://doi.org/10.1016/j.cofs.2020.04.005
Morenga, L. T., & Mann, J. (2012). The role of high-protein diets in body weight management and health. British Journal of Nutrition, 108(S2), S130-S138. https://doi.org/10.1017/S0007114512002437
Nicolai, T., & Chassenieux, C. (2021). Heat-induced gelation of casein micelles. Food Hydrocolloids, 118, 106755. https://doi.org/10.1016/j.foodhyd.2021.106755
Pasiakos, S. M., Cao, J. J., Margolis, L. M., Sauter, E. R., Whigham, L. D., McClung, J. P., Rood, J. C., Carbone, J. W., Combs, G. F., & Young, A. J. (2013). Effects of high-protein diets on fat-free mass and muscle protein synthesis following weight loss: a randomized controlled trial. The FASEB Journal, 27(9), 3837-3847. https://doi.org/10.1096/fj. 13-230227
Perez, D., Harte, F., & Lopez-Pedemonte, T. (2022). Ionic strength and buffering capacity of emulsifying salts determine denaturation and gelation temperatures of whey proteins. Journal of Dairy Science, 105(9), 7230-7241. https://doi.org/10.3168/jds.2021-21738
Pinto, I. S. S., Neto, I. F. F., & Soares, H. M. V. M. (2014). Biodegradable chelating agents for industrial, domestic, and agricultural applications—a review. Environmental Science and Pollution Research, 21(20), 11893-11906. https://doi.org/10.1007/s11356-014-2592-6
Quan, T. H., Benjakul, S., Sae-leaw, T., Balange, A. K., & Maqsood, S. (2019). Protein-polyphenol conjugates: Antioxidant property, functionalities and their applications. Trends in Food Science & Technology, 91, 507-517. https://doi.org/10.1016/j.tifs.2019.07.049
Rafiee Tari, N., Gaygadzhiev, Z., Guri, A., & Wright, A. (2021). Effect of pH and heat treatment conditions on physicochemical and acid gelation properties of liquid milk protein concentrate. Journal of Dairy Science, 104(6), 6609-6619. https://doi.org/10.3168/jds.2020-19355
Rahayu, P. P., Manab, A., Sawitri, M. E., Andriani, R. D., Apriliyani, M. W., & Thohari, I. (2021). Interactions between Cocoa Husk Catechin and Casein Micelles and their Impact on Physico-chemical Properties. Asian Food Science Journal, 20(2), 21-33. https://doi.org/10.9734/afsj/2021/v20i230261
Rashidinejad, A., Tarhan, O., Rezaei, A., Capanoglu, E., Boostani, S., Khoshnoudi-Nia, S., Samborska, K., Garavand, F., Shaddel, R., Akbari-Alavijeh, S., & Jafari, S. M. (2022). Addition of milk to coffee beverages; the effect on functional, nutritional, and sensorial properties. Critical Reviews in Food Science and Nutrition, 62(22), 6132-6152. https://doi.org/10.1080/10408398.2021.1897516
Rauser, W. E. (1999). Structure and function of metal chelators produced by plants. Cell Biochemistry and Biophysics, 31(1), 19-48. https://doi.org/10.1007/BF02738153
Salunke, P., Marcella, C., & Metzger, L. (2021). Microfiltration and Ultrafiltration process to produce Micellar Casein and Milk Protein Concentrates with 80% Crude Protein Content: Partitioning of various protein fractions and constituents. Dairy Science Publication Database, 2. https://openprairie.sdstate.edu/dairy_pubdb/2371
Singh, J., Prakash, S., Bhandari, B., & Bansal, N. (2019). Ultra high temperature (UHT) stability of casein-whey protein mixtures at high protein content: Heat induced protein interactions. Food Research International, 116, 103-113. https://doi.org/10.1016/j.foodres.2018.12.049
Singh, R., Rathod, G., Meletharayil, G. H., Kapoor, R., Sankarlal, V. M., & Amamcharla, J. K. (2022). Invited review: Shelf-stable dairy protein beverages—Scientific and technological aspects. Journal of Dairy Science, 105(12), 9327-9346. https://doi.org/10.3168/jds.2022-22208
Stribiţcaia, E., Blundell, J., You, K.-M., Finlayson, G., Gibbons, C., & Sarkar, A. (2022). Viscosity of food influences perceived satiety: A video based online survey. Food Quality and Preference, 99, 104565. https://doi.org/10.1016/j.foodqual.2022.104565
Tian, Q., Fan, Y., Hao, L., Wang, J., Xia, C., Wang, J., & Hou, H. (2023). A comprehensive review of calcium and ferrous ions chelating peptides: Preparation, structure and transport pathways. Critical Reviews in Food Science and Nutrition, 63(20), 4418-4430. https://doi.org/10.1080/10408398.2021.2001786
van de Langerijt, T. M., O'Mahony, J. A., & Crowley, S. V. (2023). Structural, Binding and Functional Properties of Milk Protein-Polyphenol Systems: A Review. Molecules, 28(5), 2288. https://doi.org/10.3390/molecules28052288
Vogel, K. G., Carter, B. G., Cheng, N., Barbano, D. M., & Drake, M. A. (2021a). Ready-to-drink protein beverages: Effects of milk protein concentration and type on flavor. Journal of Dairy Science, 104(10), 10640-10653. https://doi.org/10.3168/jds.2021-20522
Vogel, K. G., Carter, B. G., Cheng, N., Barbano, D. M., & Drake, M. A. (2021b). Ready-to-drink protein beverages: Effects of milk protein concentration and type on flavor. Journal of Dairy Science, 104(10), 10640-10653. https://doi.org/10.3168/jds.2021-20522
von Staszewski, M., Jagus, R. J., & Pilosof, A. M. R. (2011). Influence of green tea polyphenols on the colloidal stability and gelation of WPC. Food Hydrocolloids, 25(5), 1077-1084. https://doi.org/10.1016/j.foodhyd.2010.10.004
von Staszewski, M., Jara, F. L., Ruiz, A. L. T. G., Jagus, R. J., Carvalho, J. E., & Pilosof, A. M. R. (2012). Nanocomplex formation between β-lactoglobulin or caseinomacropeptide and green tea polyphenols: Impact on protein gelation and polyphenols antiproliferative activity. Journal of Functional Foods, 4(4), 800-809. https://doi.org/10.1016/j.jff.2012.05.008
Wagoner, T. B., çakir-Fuller, E., Shingleton, R., Drake, M., & Foegeding, E. A. (2020). Viscosity drives texture perception of protein beverages more than hydrocolloid type. Journal of Texture Studies, 51(1), 78-91. https://doi.org/10.1111/jtxs. 12471
Wu, G. (2016). Dietary protein intake and human health. Food & Function, 7(3), 1251-1265. https://doi.org/10.1039/C5F001530H
Zhao, Z., & Corredig, M. (2016). Short communication: Serum composition of milk subjected to re-equilibration by dialysis at different temperatures, after pH adjustments. Journal of Dairy Science, 99(4), 2588-2593. https://doi.org/10.3168/jds.2015-9917.

### EXAMPLES

### Example 1: Production of a Reduced Viscosity Milk Protein Beverage with Cocoa

An example formulation/methodology for production of a reduced viscosity milk protein beverage with cocoa is as follows. In a shear tank, 190 °F water was combined with antifoam (0.01-0.05% w/w) and pectin (0.01%-0.08% w/w), then mixed for 5 minutes to properly disperse and hydrate the pectin. After this mixing, the rest of the dry ingredients were added (sucralose (0.0005-0.001 w/w), acesulfame potassium (0.0025-0.001% w/w), Monk fruit (0.003-0.009% w/w), sea salt (0.08-0.15% w/w), cocoa powder (0.2-2.0% w/w), A&D vitamin mix (0.004-0.010% w/w)), including the calcium chelating salt/agent (Di-potassium phosphate added at 0.05-0.3% w/w), and the wet ingredients were also added (water (7.0-13.0% w/w), ultrafiltered (UF) milk (45-85% w/w), cream (0.6-2.0% w/w)).

An example formulation/methodology for production of a reduced viscous protein beverage with strawberry or vanilla flavor is as follows. In a shear tank, 190 °F water was combined with antifoam (0.01-0.05% w/w) and pectin (0.01%-0.08% w/w), then mixed for 5 minutes to properly disperse and hydrate the pectin. After this mixing, the rest of the dry ingredients were added (sucralose (0.0005-0.001 w/w), acesulfame potassium (0.0025-0.001% w/w), Monk fruit (0.003-0.009% w/w), sea salt (0.08-0.15% w/w), A&D vitamin mix (0.004-0.010% w/w)), including the calcium chelating salt/agent (Di-potassium phosphate added at 0.05-0.3% w/w), and the wet ingredients were also added (water (7.0-13.0% w/w), UF milk (45-85% w/w), cream (0.6-2.0% w/w)). The beverage is then heated and homogenized before flavorant addition. The flavors are then added and blended in after homogenization.

### Example 2: Production of a Reduced Viscosity Milk Protein Beverage with Coffee

An example formulation/methodology for production of a reduced viscous protein beverage with coffee is as follows. In a shear tank, 190 °F water was combined with antifoam (0.01-0.05% w/w) and pectin (0.03%-0.11% w/w), then mixed for 5 minutes to properly disperse and hydrate the pectin. After this mixing, the rest of the dry ingredients were added (sucralose (0.005-0.015 w/w), acesulfame potassium (0.005-0.01% w/w), Monk fruit (0.004-0.01% w/w), sea salt (0.04-0.12% w/w), coffee extract/spray dried coffee (0.05-10% w/w), including the calcium chelating salt/agent (di-potassium phosphate added at 0.05-0.3% w/w), and the wet ingredients were also added (water (7.0-13.0% w/w), UF milk (45-85% w/w), cream (0.6-2.0% w/w)).

Other formulations of the reduced viscosity beverages could contain reconstituted milk protein from milk protein concentrate (MPC) or milk protein isolates (MPI). One study (Kort et al., 2012) utilized MPI which contained 85% protein and less than 5% whey protein, indicating it had a reduced whey protein content dissimilar to UF milk utilized above. These ingredients can be formulated to be reconstituted with water added and replace or be added with the UF milk listed above. The MPI can be rehydrated in water (7-15% w/w) and homogenized before addition into the shear tank.

These combined formulated samples were then mixed to properly disperse ingredients and heated to 150-160 °F before continuation. After mixing, homogenization of the whole mixture was completed in 2 stages: stage 1 at 3500 psi, and stage 2 at 500 psi for a total of 4000 psi before flavor addition and thermal processing.

After homogenization, more water (5-12% w/w) and natural flavors (nonlimiting examples include vanilla, strawberry, or chocolate) (0.01-1% w/w) were added and mixed in before thermal processing. The thermal processing element in this product is retort processing. Thermal processing occurred in 12 fluid oz cans with a maximum fill weight of 357.0 g with a protein beverage with maximum of 15.82% solids. The minimum cook parameters were a minimum cook temperature of 254 °F for a minimum cook time of 7.3 minutes. Harsher cooking conditions were acceptable.

### Example 3: Coffee and Cocoa Destabilize the Viscosity of Ultrafiltered Milk when Cooled

This study found that polyphenol-rich additives can contribute to an increase in temperature-dependent viscosity shift.

Study Design: In this study, spray dried coffee and cocoa were added (0-0.5%) to UF milk without other additives to determine cocoa and coffee's effect on viscosity of retorted and heat treated UF milk. The viscosity of retorted UF milk over various temperatures was also analyzed.

Results: Overall, the addition of coffee and cocoa up to 0.5% did not affect the viscosity of the system at room temperature but significantly changed the viscosity of the system when the UF milk was cooled, resulting in a viscosity shift in the matrix. A significant change in viscosity under refrigerated conditions was observed at levels even at low as 0.01% for coffee and cocoa. Cocoa in the system affected the system more than coffee. This study demonstrated that a high protein milk with polyphenolic additives could have an exaggerated increase in viscosity when chilled compared to UF milk without it, thus demonstrating an unstable viscosity.

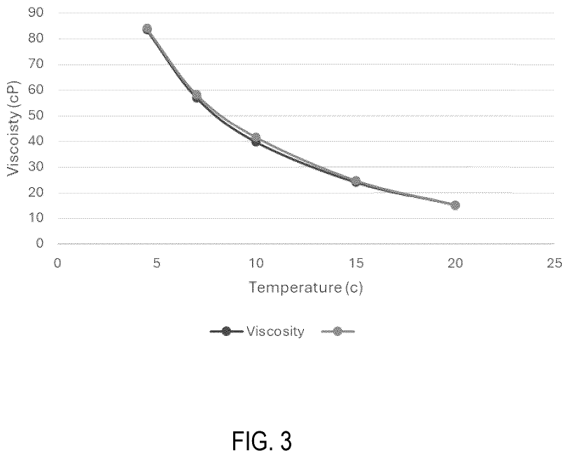

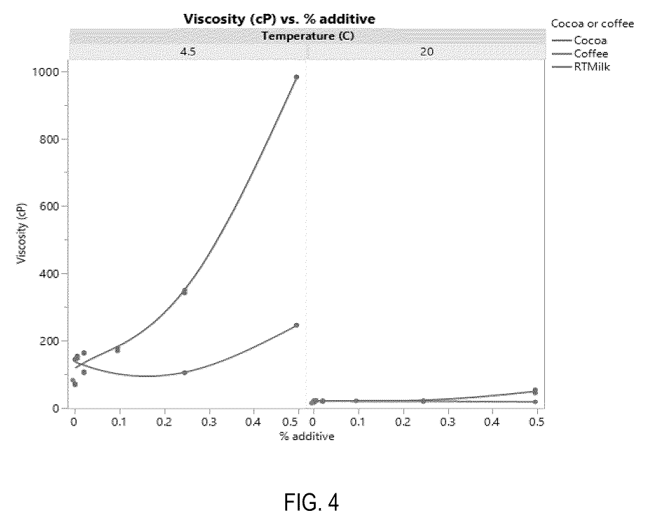

FIG. 3 shows the viscosity of retorted UF milk at various temperatures from 5 to 20 °C. FIG. 4 shows a comparison of UF milk viscosity differences at refrigerated (left) and room temperatures (right) between samples with either coffee (red) or cocoa (blue) added at different weight %.

### Example 4: Natural Cocoa, with Higher Polyphenol Content than Alkalized Cocoa, Produced a Milk Protein Beverage with a More Unstable Viscosity

This study found that alkalization of cocoa stripped a significant amount of polyphenolic compounds from cocoa. Therefore, if polyphenolic compounds drive an increase in viscosity, beverages with natural cocoa may have a higher viscosity compared to beverages with alkalized cocoa.

Study Design: A high-protein milk protein beverage was made with different types of cocoa, no cocoa, two different alkalized cocoas (one alkalized with potassium carbonate, the other sodium carbonate), natural cocoa, and natural cocoa with high fat. This was done to determine whether cocoa composition could affect the viscosity of a high protein beverage. Each sample was made with 0% and 0.08% of a calcium chelator to determine its ability to minimize the different cocoa's effect on temperature driven viscosity stability.

Results: Natural cocoa resulted in gelation of the milk protein beverage and a large increase in viscosity at lower temperatures. After 0.08% of the chelator was added, a major viscosity controlling effect was observed.

This gelation and viscosity phenomenon did not appear to be macronutrient composition dependent or pH dependent, as the composition and pH of the samples varied minimally as presented in Table 1.

TABLE 1
Compositional analysis of a protein drink made with no cocoa, natural cocoa,
and alkalized cocoa. “DKP” is di-potassium phosphate.

| | No cocoa | | Natural cocoa | | Alkalized cocoa | |
|---|---|---|---|---|---|---|
| | 0% DKP | 0.08% DKP | 0% DKP | 0.08% DKP | 0% DKP | 0.08% DKP |
| Protein | 9.87 | 9.72 | 9.29 | 9.41 | 9.22 | 9.26 |
| Fat | 0.51 | 0.43 | 0.59 | 0.51 | 0.52 | 0.51 |
| Solids | 11.94 | 12.04 | 11.97 | 12.25 | 11.9 | 11.89 |
| Initial pH | 6.74 | 6.79 | 6.68 | 6.73 | 6.86 | 6.9 |
| Retorted pH | 6.51 | 6.55 | 6.44 | 6.48 | 6.64 | 6.66 |
| Density | 1.03526 | 1.035055 | 1.03481 | 1.0362 | 1.03522 | 1.03594 |

This phenomenon was also observed in the non-cocoa samples indicating that a calcium chelator can even prevent viscosity differences in beverages without cocoa, possibly by a different mechanism. While observed, this phenomenon was not as readily observed in alkalized cocoa, suggesting that polyphenols may be important in destabilization of the viscosity in milk protein beverages.

However, as the shelf life goes on, an increase in viscosity of the refrigerated samples may be observed, which may be minimized by the addition of the chelator regardless of the type of cocoa used, or the amount of cocoa used, if any.

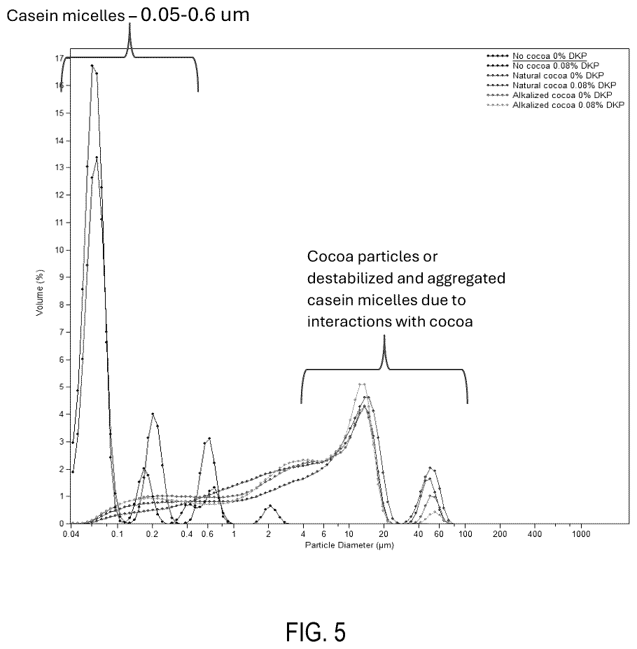

The particle size analysis shown in FIG. 5 indicates that cocoa may interact with milk particles. FIG. 5 shows a particle size distribution of a beverage according to some embodiments with no cocoa (blue and brown), natural cocoa (red and green), and alkalized cocoa (pink and orange), with and without the presence of 0.08% DKP. Once cocoa was added, the particle sizes for casein micelles disappeared, demonstrating either dissociation or aggregation of the casein particles with cocoa molecules. This phenomenon was not particular to either type of cocoa, as it was observed in both natural and alkalized cocoa beverages.

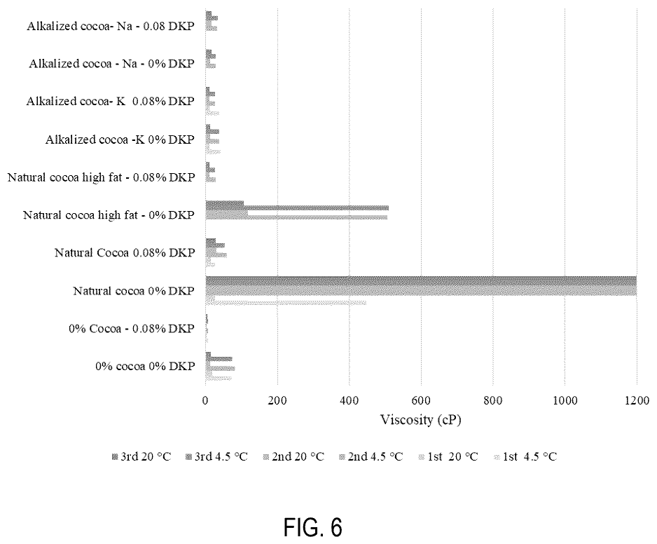

FIG. 6 shows viscosity differences of a high-protein beverage with no cocoa, alkalized cocoa, and natural cocoa after 1 week of storage under room temperature and refrigerated conditions, measured at both 4.5 °C (refrigerated-blue) and 20 °C (room temperature-orange) over 3 different trials.

### Example 5: Addition of Various Amounts of a Calcium Chelator into a Milk Protein Beverage with Natural Cocoa Minimized Viscosity Instability Across Temperature

This study demonstrated the effectiveness of a calcium chelator in a beverage with natural cocoa to prevent polyphenol/protein or polyphenol/calcium interactions leading to higher viscosity.

Study Design: The high protein beverage was formulated like previously with the two differences being the amount of the chelator added to determine its effect on viscosity regulation, and the use of natural cocoa instead of alkalized cocoa to understand polyphenol content's role in viscosity changes. The chelator was added in varying amounts from (0-0.16%) and added after homogenization. The finished product was then stored under ambient and refrigerated conditions to monitor the effects of extended temperature exposure and the ability of the chelator to minimize viscosity differences between the two samples.

Results: After a 0.08% chelator addition, gelation was prevented in the beverage, and viscosity differences driven by storage temperature were minimized. The results demonstrate the ability of a calcium-binding chelator to minimize viscosity shifts driven by cold temperatures. This reduction in temperature driven viscosity was observed until 0.5% of the chelator was added, after which refrigerated temperature viscosities started to rise. Thus, in some embodiments, 0-0.5% of a chelator by weight may be a preferred content range to achieve viscosity modulation of the milk protein beverage with natural cocoa. The results shown were after one week of shelf life.

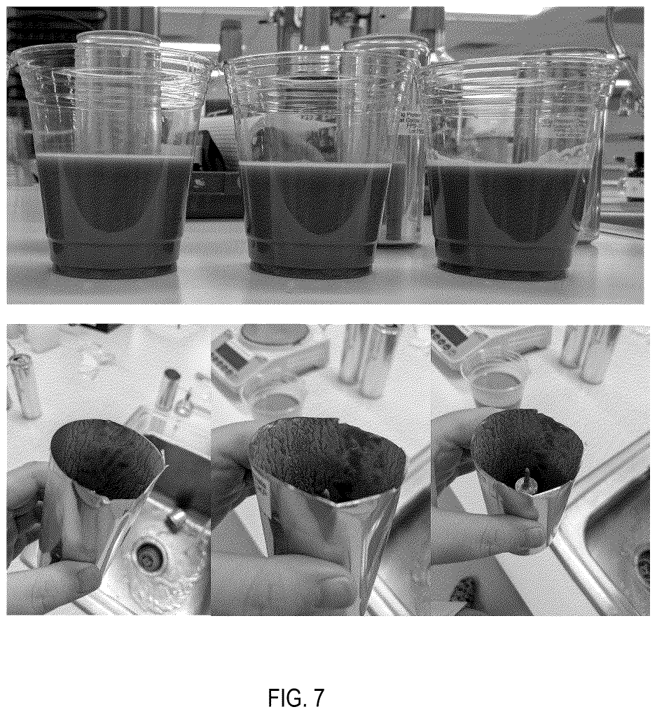

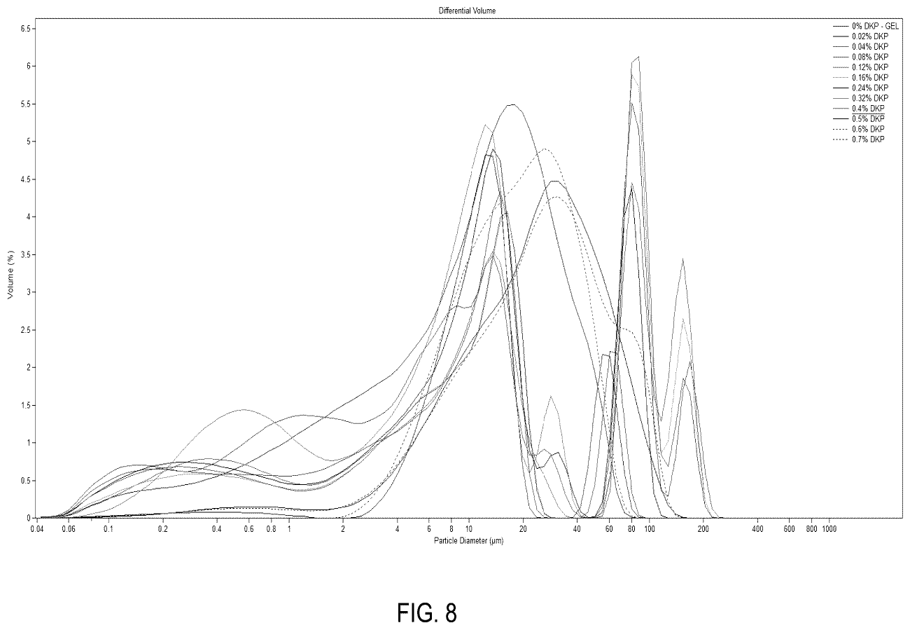

After 0.5% of a chelator was added, the beverages became unstable and started to break, with separation and protein aggregation observed in FIG. 7. FIG. 7 shows visual images of broken beverages (top) and the aggregation (bottom) from a protein beverage made with 0.5% (left), 0.6% (middle), and 0.7% (right) DKP. Without being bound by theory, this may be due to a combination of electrostatic shielding from the DKP salt resulting in a reduction of electrostatic interactions, and repulsion, leading to some micelle dissociation, more protein-protein hydrophobic interactions, and the retort thermal processing causing extreme aggregation under these conditions. This theory is supported by the particle size analysis shown in FIG. 8. FIG. 8 depicts particle size analyses of a milk protein drink comprising natural cocoa and various amounts of DKP, from 0 to 0.70%. The 0% chelator protein beverage gel, and the protein beverage with 0.5-0.7% calcium chelator content, had particle size distributions with a large broad peak with no particles within the casein micelle region and no other peaks, indicating aggregation of the smaller particles. When the chelator range was between 0.02-0.4%, the samples all demonstrated a very similar particle size profile, with only minor shifts being observed as the amount increased. This could demonstrate that the chelator salt prevented intermolecular interactions and prevented aggregation or bridging, as observed in the stable particle size distributions until 0.5%. After this point it is possible that the further screening of electrostatic interactions leads to more protein-protein hydrophobic interactions, protein aggregation, and the destabilization of the product.

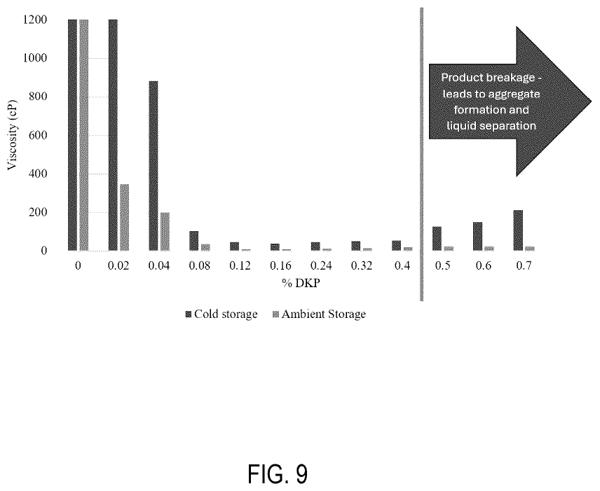

FIG. 9 shows viscosity differences of a protein beverage made with natural cocoa and 0, 0.02, 0.04, 0.08, 0.12, 0.16, 0.24, 0.32, 0.4, 0.5, 0.6, and 0.7% addition of a calcium chelator at refrigerated (blue) and room temperature (orange).

### Example 6: Addition of Various Amounts of Calcium Chelator into a Milk Protein Beverage with Alkalized Cocoa Maintained Temperature-Stable Viscosity after Prolonged Exposure to Chilled Temperatures

This study showed that the presence of a calcium chelator (0 to 0.16%) inhibited the temperature driven viscosity change and maintained a stable viscosity over time.

Study Design: A high protein beverage was formulated in the same way as previous studies with alkalized cocoa. The chelator was added in varying amounts (0 to 0.32%). Samples were then stored under room temperature and refrigerated conditions to monitor the effects of extended temperature exposure and the ability of the addition of a chelating salt to minimize viscosity differences between samples at two different temperatures.

Results: Over 4 weeks, the addition of 0.04 and 0.08% of a calcium chelator resulted in a high protein beverage matrix with a consistent, stable, and flowable viscosity. The addition of 0, 0.16, 0.24, and 0.32% of a calcium chelator produced a high protein beverage with a viscosity that increased over time at refrigerated temperature, demonstrating an unstable and inconsistent viscosity. This unexpected finding further demonstrates, in some embodiments, a need for a specific active range of chelator, depending on the cocoa type. For example, alkalized cocoa may require less of the chelator to be active, and thus may have a smaller functional range for this chelator compound. Without being bound by theory, this could be driven by the reduction of polyphenols in the alkalized cocoa, or the salt addition during the alkalization process contributing to the reduction of viscosity.

The particle size analyses of the samples from week 1 to week 4 shows stabilization and consistency in particle sizes for 0-0.16% of the chelating salt. After 0.16% of the chelator was added, a reduction in the smaller particles was observed, similar to the natural cocoa study, indicating that the product could be destabilizing. This was also observed with viscosity data, as the viscosity started to increase under refrigerated conditions at 0.16% chelator addition, and continued to increase as more was added (data not shown). Therefore, this data also demonstrates a specific active range of the chelator with the alkalized cocoa product, that is different than natural cocoa.

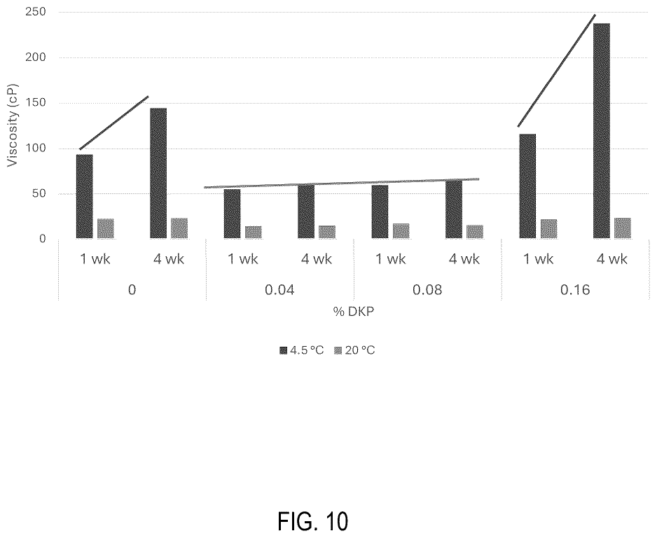

FIG. 10 shows the viscosities of beverages with various amounts of a calcium chelator (0 to 0.16%) added after storage under room temperature and refrigerated conditions for 1 week and 4 weeks.

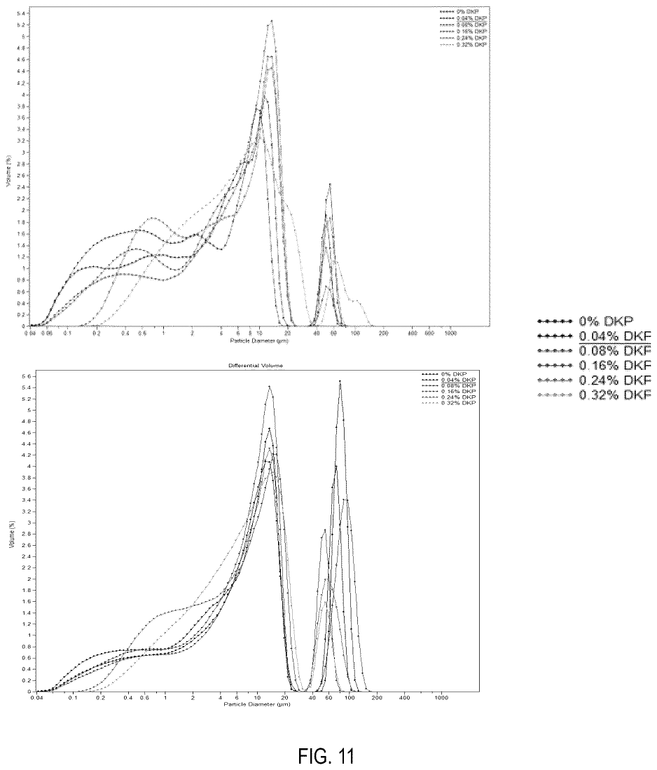

FIG. 11 shows particle size analysis of a protein drink made with alkalized cocoa and various amounts of DKP (0 to 0.32% DKP) at 1 week of storage (top) and 4 weeks of storage (bottom).

What is claimed is:

1. An ultrafiltered milk protein beverage, comprising:
milk protein having a concentration of 4 to 20% w/w;
one or more calcium-binding chelator compound having a concentration of 1 to 30 mM; and
one or more flavorant,
wherein the ultrafiltered milk protein beverage has a viscosity difference of less than 150 cP across a temperature range of 2 to 30 °C.

2. The ultrafiltered milk protein beverage of claim 1, wherein the one or more flavorant comprises a vanilla flavorant.

3. The ultrafiltered milk protein beverage of claim 1, wherein the one or more calcium-binding chelator compound comprises a sodium salt of a polyphosphate.

4. The ultrafiltered milk protein beverage of claim 1, wherein the milk protein has a concentration of 8% to 10% w/w.

5. The ultrafiltered milk protein beverage of claim 3, wherein the sodium salt of the polyphosphate has a concentration of 10 to 20 mM.

6. The ultrafiltered milk protein beverage of claim 1, wherein the viscosity difference is less than 90 cP across the temperature range.

7. The ultrafiltered milk protein beverage of claim 1, wherein the milk protein comprises from 50% to 100% casein, at least a portion of the casein comprising casein micelles.

8. The ultrafiltered milk protein beverage of claim 1, wherein a flow behavior index of the ultrafiltered milk protein beverage is from 0.8 to 1.1 and a shear stress of the ultrafiltered milk protein beverage is proportional to a shear rate of the ultrafiltered milk protein beverage.

9. The ultrafiltered milk protein beverage of claim 8, wherein the ultrafiltered milk protein beverage is a Newtonian fluid.

10. The ultrafiltered milk protein beverage of claim 1, produced by retort processing.

11. The ultrafiltered milk protein beverage of claim 1, wherein the ultrafiltered milk protein beverage is in a closed container; optionally, wherein the closed container is a can, bottle, or pouch.

12. An ultrafiltered milk protein beverage, comprising:
milk protein having a concentration of 8% to 10% w/w;
a sodium salt of a polyphosphate having a concentration of 10 to 20 mM; and
one or more vanilla flavorant,
wherein the ultrafiltered milk protein beverage has a viscosity difference of less than 90 cP across a temperature range of 2 to 30 °C.

13. The ultrafiltered milk protein beverage of claim 12, wherein a flow behavior index of the ultrafiltered milk protein beverage is from about 0.8 to about 1.1 and a shear stress of the ultrafiltered milk protein beverage is proportional to a shear rate of the ultrafiltered milk protein beverage.

14. The ultrafiltered milk protein beverage of claim 13, wherein the ultrafiltered milk protein beverage is a Newtonian fluid.

15. The ultrafiltered milk protein beverage of claim 12, produced by retort processing.

16. The ultrafiltered milk protein beverage of claim 12, produced by a method comprising:
forming a liquid comprising the milk protein, the sodium salt of the polyphosphate, and the one or more vanilla flavorant;
homogenizing the liquid at a pressure of from 2500 to 5000 psi; and
thermally processing the liquid to form the ultrafiltered milk protein beverage, the thermal processing comprising a temperature of at least 100 °C for a duration of at least 4 minutes,
wherein the thermal processing comprises retort processing.

17. The ultrafiltered milk protein beverage of claim 16, wherein the thermal processing comprises a temperature of from 105 °C to 140 °C and a duration of from 4 to 10 minutes.

18. A method of producing a high-protein ultrafiltered milk beverage, the method comprising:
forming a first liquid comprising water and one or more calcium-binding chelator compound, the one or more calcium-binding chelator compound having a concentration of from 0.5% w/w to 2% w/w;
forming a second liquid comprising an ultrafiltered milk concentrate having a milk protein concentration of from 8% w/w to 10% w/w;
combining the first liquid and the second liquid to form a third liquid;
homogenizing the third liquid at a pressure of from about 2500 psi to about 5000 psi; and
thermally processing the third liquid to form the high-protein ultrafiltered milk beverage, the thermal processing comprising a temperature of at least 100 °C to for a duration of at least 4 minutes,
wherein all concentrations are provided relative to a total concentration of the high-protein ultrafiltered milk beverage.

19. The method of claim 18, wherein the high-protein ultrafiltered milk beverage comprises one or more vanilla flavorant.

20. The method of claim 18, wherein the one or more calcium-binding chelator compounds comprises a sodium salt of a polyphosphate.

21. The method of claim 18, wherein the thermal processing comprises a temperature of from about 105 °C to 140 °C and a duration of from 4 to 10 minutes.

22. The method of claim 18, wherein the thermal processing comprises retort processing.
